(19) United States
(12) Patent Application Publication
(10) Pub. No.: US 2008/0300893 A1
(43) Pub. Date: Dec. 4, 2008

(54) ASSISTANCE PROGRAM ENROLLMENT METHOD AND COMPUTER READABLE CODE

(75) Inventors: Jerardo Mendoza, Gilbert, AZ (US); Susan M. Cibrario, Sun City, AZ (US)

Correspondence Address: MESCHKOW & GRESHAM, P.L.C., 5727 NORTH SEVENTH STREET, SUITE 409, PHOENIX, AZ, 85014, US

(73) Assignee: ARIZONA PUBLIC SERVICE COMPANY, Phoenix, AZ (US)

(21) Appl. No.: 11/757,185

(22) Filed: Jun. 1, 2007

(51) Int. Cl. G06Q 99/00; G06F 17/30

(52) U.S. Cl. 705/1

(57) ABSTRACT

A method of making an assistance program offered by a provider available to a client includes receiving, at a computing system, client information pertaining to a social benefit program for which the client qualifies from an organization that administers the social benefit program. The client information is compared with eligibility requirements for the assistance program. When the client information meets the eligibility requirements, the organization is notified of an eligibility of the client to enroll in the assistance program. Computer readable code communicates the notification of client eligibility to an administering organization can enroll the client in the assistance program.

### TECHNICAL FIELD OF THE INVENTION

The present invention relates to the field of assistance programs. More specifically, the present invention relates to a method which may be implemented within a computing environment for facilitating the enrollment of a client in an assistance program.

### BACKGROUND OF THE INVENTION

Households in poverty spend a disproportionately high percentage of their annual income on energy and telephone bills to maintain their modest levels of usage relative to middle- and high-income households. Moreover, in recent years, energy costs have been rapidly rising, thus placing even greater financial pressure on low- and moderate-income consumers.

An array of social benefit programs is available to qualified citizens, resident aliens, foreign nationals, and undocumented persons residing in the United States of America. One social benefit program intended to assist households with heating and cooling costs is a federally funded Low Income Home Energy Assistance Program (LIHEAP). LIHEAP provides funds to states, Indian tribes or tribal organizations, and insular areas who administer the funds to help low-income households pay home energy expenses. LIHEAP funds may be used to assist households with heating and cooling costs, provide crisis assistance, and pay for weatherization projects.

The various social benefit programs, including LIHEAP, are generally need based and means tested to ensure that only those who are deserving and qualify for the benefits receive them. That is, a needy household fills out an application, which is then verified for accuracy, in order to qualify for the program. Various social service agencies and nonprofit organizations assist the needy in identifying the appropriate social benefit programs, in obtaining funds from such programs, and in applying those funds in accordance with program rules.

Many service providers, such as utility companies and cooperatives, additionally have utility assistance programs to allow low-income households an opportunity to obtain a discount on their utility and/or telephone bills. Unfortunately, knowledge of these utility assistance programs, sometimes referred to as low-income discount programs, is not always disseminated effectively to those who are most in need. Consequently, enrollment in such utility assistance programs offered by service providers may be undesirably low.

In many instances, in order to enroll in a utility assistance program, a potential client is obligated to fill out an application. The process of applying for the utility assistance program may be insurmountable due to poor or nonexistent English language skills within a household. For other individuals, filling out and mailing in the required forms may be too much trouble. Still other individuals may resist anything that looks like welfare, and others may fear that the discounted rate would count against them in applying for other social service benefits.

Another problem that can arise is that the information provided by the potential client in an assistance program enrollment application is not typically verified by an independent authority. Consequently, a large potential exists for fraudulent applications.

Accordingly, what is needed is a technique for making an assistance program, such as a low-income discount program, offered by a service provider available to those households most in need of the assistance. What is further needed is a technique for largely limiting the number of fraudulent users of such an assistance program.

### SUMMARY OF THE INVENTION

Accordingly, it is an advantage of the present invention that a method and computer readable code are provided for making an assistance program offered by a provider available to individuals.

It is another advantage of the present invention that a method and computer readable code are provided that effectively disseminate enrollment information regarding a provider offered assistance program to those who are most in need.

Another advantage of the present invention is that a method and computer readable code are provided for facilitating enrollment of individuals in an assistance program that largely limits the number of fraudulent users of such an assistance program.

The above and other advantages of the present invention are carried out in one form in a computing environment, by a method of making an assistance program offered by a provider available to a client. The method calls for receiving, at the computing environment, client information pertaining to a social benefit program for which the client qualifies from an organization that administers the social benefit program. The client information is compared with eligibility requirements for the assistance program. When the client information meets the eligibility requirements, the organization is notified of an eligibility of the client to enroll in the assistance program. Enrollment of the client in the assistance program is facilitated in response to the notifying operation.

The above and other advantages of the present invention are carried out in another form by a computer-readable storage medium containing executable code for instructing a processor to make a low-income discount program offered by a provider available to a client. The executable code instructs the processor to perform operations that include receiving client information pertaining to a social benefit program for which the client qualifies from an organization that administers the social benefit program. The client information includes verified income information for the client that is commonly required by both the social benefit program and the low-income discount program. The client information is compared with eligibility requirements for the low-income discount program. When the client information meets the eligibility requirements, the organization is notified of an eligibility of the client to enroll in the low-income discount program and enrollment of the client in the low-income discount program is facilitated in response to the notifying operation.

### BRIEF DESCRIPTION OF THE DRAWINGS

A more complete understanding of the present invention may be derived by referring to the detailed description and claims when considered in connection with the Figures, wherein like reference numbers refer to similar items throughout the Figures, and:

FIG. 1 shows a block diagram of an environment in which the present invention may be implemented;

FIG. 2 shows a flowchart of a payment guarantee process that includes an assistance program enrollment process that may be executed within the computing environment of FIG. 1;

FIG. 3 shows a table of eligibility requirements for an assistance program offered by a provider; and

FIG. 4 shows a view of a screen shot in which enrollment for an eligible client to an assistance program is made available to an organization in accordance with an embodiment of the present invention.

### DETAILED DESCRIPTION OF THE PREFERRED EMBODIMENTS

The present invention provides methodology and computer readable code for making an assistance program offered by a provider available to a qualified client. The present invention verifies a client's eligibility for the assistance program and enables efficient notification to an administering organization of a client's eligibility for the assistance program. In addition, the present invention enables the organization to enroll the client in the assistance program.

An assistance program may be a low-income discount program offered by a utility service provider such as an electric company, a gas company, a telephone company, and the like. The low-income discount program is a need based program that allows low-income households an opportunity to obtain discounts on their utility and/or telephone bills. However, the present invention need not be limited to use in conjunction with services and products provided by utility service providers. In addition, the present invention may be adapted for use in conjunction with a number of need based programs offered by other providers in which eligibility for the programs should be verified prior to obtaining benefits from these need based programs.

The present invention entails computer-readable assistance program enrollment code, in the form of an assistance program enrollment process, that facilitates the enrollment of clients into a service provider's low-income discount program who have already qualified for a social benefit program through an administering organization or agency. In one embodiment, the assistance program enrollment process is a program code module that is included as part of a payment guarantee process utilized by various organizations, discussed below. However, the assistance program enrollment process need not be limited to such a use, but may instead be implemented as a stand-alone program utilized by the various organizations.

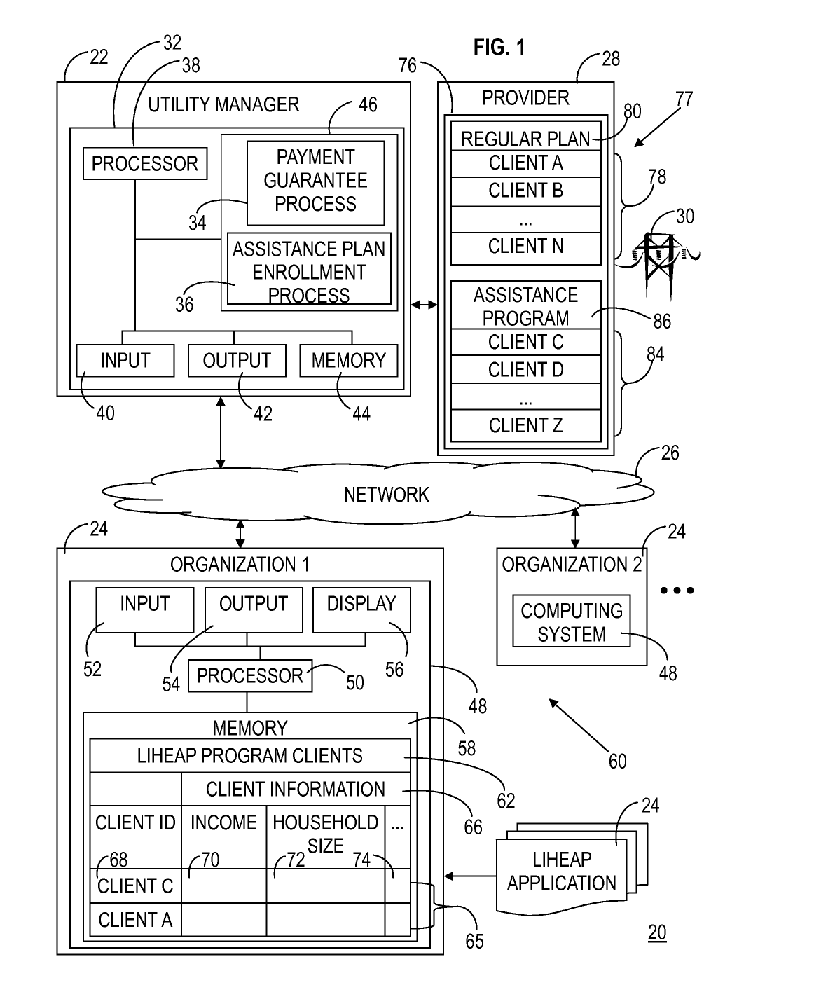

FIG. 1 shows a block diagram of an environment 20 in which the present invention may be implemented. Environment 20 includes a utility manager 22 that may be in communication with various organizations 24 via a network, represented by a cloud element 26. Network 26 may be the worldwide, publicly accessible network of interconnected computer networks, referred to as the Internet.

Utility manager 22 is also in communication with a provider 28, which in this exemplary scenario is a provider of electricity 30. Utility manager 22 may be an independent entity from provider 28. Alternatively, utility manager 22 may be a subsidiary of provider 28. Environment 20 may include any number of organizations 24, of which two are shown, that are enrolled in a program managed by utility manager 22, discussed below. Organizations 24 represent any number of organizations, such as social services, community agencies, nonprofit agencies, and the like whose primary involvement may be related to social issues, charities, and so forth.

In the exemplary scenario of FIG. 1, organizations 24 administer various social benefit programs. More particularly, organizations 24 may facilitate the enrollment of low-income individuals and households in a range of social benefit programs. These social benefit programs can include, for example, Earned Income Tax Credit (EIC), U.S. Department of Agriculture's Food Stamp Program, Children's Health Insurance Program, the Low Income Home Energy Assistance Program (LIHEAP), and other publicly or privately funded and administered programs. Organizations 24 may carry out such rolls as identifying the various social benefit programs, providing the applications for such social benefit programs, and verifying the information provided in the applications to determine whether individuals qualify for the various social benefit programs.

In one function provided in environment 20, organizations 24 administer funds associated with the Low Income Home Energy Assistance Program (LIHEAP). By way of example, for those clients who are qualified for LIHEAP assistance through one of organizations 24, that organization 24 may be authorized to guarantee payment of some or all of a client's electricity bill owed to provider 28 using LIHEAP funding. Utility manager 22 facilitates these guaranteed payments by collecting the guarantees from organizations 24, communicating the guarantee of payments to provider 28, and communicating the payments to provider 28.

Utility manager 22 includes a managing computing system 32 for executing a computer program, in the form of a payment guarantee process 34. A program code module, in the form of an assistance program enrollment process 36, is included in conjunction with payment guarantee process 34. Managing computing system 32 includes a processor 38 on which payment guarantee process 34 along with assistance program enrollment process 36 can be executed. Processor 38 is in communication with an input device 40, an output device 42, a memory system 44, and a computer-readable storage medium 46. These elements are interconnected by a conventional bus structure.

Input device 40 can encompass a keyboard, mouse, pointing device, audio device (e.g., a microphone), and/or any other device providing input to processor 38. Output device 42 can encompass a display, a printer, an audio device (e.g., a speaker), and/or other devices providing output from processor 38.

Computer-readable storage medium 46 may be a magnetic disk, compact disk, or any other volatile or non-volatile mass storage system readable by processor 38. Computer-readable storage medium 46 may also include cooperating or interconnected computer readable media, which exist exclusively on managing computing system 32 or are distributed among multiple interconnected computer systems (not shown) that may be local or remote. Payment guarantee process 34 and assistance program enrollment process 36 are recorded on computer-readable storage medium 46 and encompass executable code for instructing processor 38 to enable organizations 24 to guarantee payments to provider 28 and to make a utility assistance program, such as a low-income discount program, offered by provider 28 available to clients, discussed below.

Each of organizations 24 includes an organization computing system 48 from which payment guarantee process 34 can be accessed via network 26. Organization computing system 48 includes a processor 50. Processor 50 is in communication with an input device 52, an output device 54, a display 56, and a memory system 58. These elements are interconnected by a conventional bus structure.

Input device 52 can encompass a keyboard, mouse, pointing device, audio device (e.g., a microphone), and/or any other device providing input to processor 50. Output device 54 can encompass a display, i.e. display 56, a printer, an audio device (e.g., a speaker), and/or other devices providing output from processor 50. It should be further understood that input devices 40, 52 and output devices 42, 54 can also include network connections, modems, or other devices used for communications with one another via network 26.

Collectively, managing computing system 32 and organization computing systems 48 form a computing environment 60 through which organizations 24 guarantee payments for funds owed by their clients to provider 28 for electricity 30. In accordance with the present invention, computing environment 60 also facilitates enrollment of clients in a low-income discount program offered by provider 28 for electricity 30.

A database 62 of LIHEAP program clients may be included in memory system 58 of organization computing system 48. As briefly mentioned above LIHEAP, or Low-Income Home Energy Assistance Program, is a federally funded social benefit program that funds states, Indian tribes or tribal organizations, and insular areas so that they may help low-income households pay home energy expenses. In many instances, these localities subcontract with administering organizations 24, typically non-profit agencies, whose function, among other things, is to enroll individuals in LIHEAP in order to obtain LIPEAP assistance.

Database 62 is created and/or updated when an applicant, perhaps with the assistance of organization 24, fills out a LIHEAP application 64. LIHEAP application 64 is utilized to obtain applicant information regarding the potential eligibility for the applicant to obtain LIHEAP assistance. Such applicant information includes, for example, applicant identification, address, household income, quantity and information regarding individuals in the household, and so forth.

Through organization 24, the applicant information such as residence, employment, income, resources, energy supply and supplier, and so forth included in LIHEAP application 64 is verified for accuracy and a determination is made as to whether the applicant qualifies for LIHEAP assistance. Currently, United States federal law permits household income eligibility to be established at either 150% of the United States Department of Health and Human Service (HHS) poverty income guidelines or 60% of a state's medium income, whichever is higher. Utilizing the HHS poverty income guidelines as a qualification threshold, an applicant can qualify for LIHEAP assistance when household income is at or below 150% of the HHS poverty income guidelines.

Following verification, if an applicant qualifies for LIHEAP assistance, the appropriate client information is entered into database 62. By way of example, database 62 includes a list of clients 65 and their associated client information 66. For purposes of clarity, the terms “client” and “clients” are used to describe those individuals/households who qualify for assistance from a social benefit program, such as LIHEAP, and are thus included in database 62. Client information 66 for each of clients 65 may include a client identifier 68, a household income value 70, a household size value 72, and additional information 74 that may have been provided in LIHEAP application 64. The information provided in database 62 and acquired when applying for LIHEAP funds is advantageously utilized by assistance program enrollment process 36 to determine a client's eligibility for additional help through the assistance program offered by provider 28.

As shown in FIG. 1, provider 28 maintains, among other things, a comprehensive database 76 containing customer records 77. Database 76 includes records 77 for a subset of customers 78 utilizing and paying for electricity 30 in accordance with a regular energy payment plan 80. In addition, provider 28 can maintain in database 76 a subset of customers 84 who may be enrolled in a utility assistance program 86, such as a low-income discount program, offered by provider 28. Database 76 is provided herein for purposes of illustration. Those skilled in the art will recognize that information contained in database 76 may be combined, organized, and maintained in any manner preferred by provider 28.

For purposes of distinction, the terms “customer” and “customers” are used herein to describe those individuals/households who receive and pay for electricity from provider 28. Customers 78 and 84 may be, but are not necessarily, clients 65 who qualify for LIHEAP assistance. However, those clients 65 who qualify for LIHEAP assistance may be customers 78 on regular energy plan 80 or may be customers 84 on assistance program 86. The present invention identifies clients 65 who qualify for LIHEAP assistance but are currently customers 78 on regular energy plan 80. Once these customers 78 are identified, the present invention facilitates their enrollment in assistance program 86.

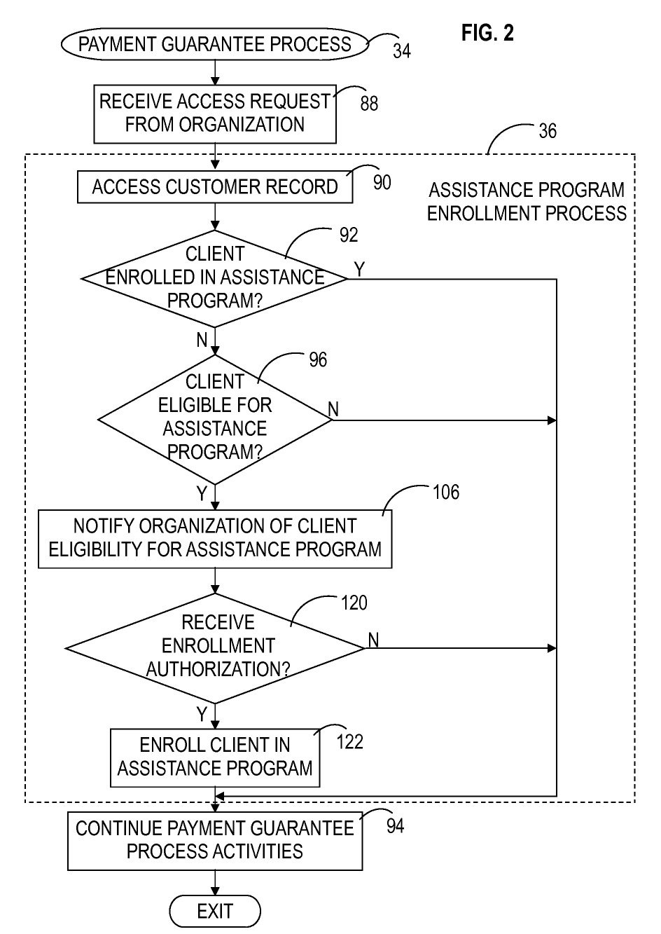

FIG. 2 shows a flowchart of payment guarantee process 34 that includes assistance program enrollment process 36 that may be executed within computing environment 60 (FIG. 1). Payment guarantee process 34 includes program code executed on managing computing system 32 (FIG. 1) and accessible by authorized organizations 24 (FIG. 1) via network 26 to enable organizations to guarantee payments to provider 28 for costs associated with electricity 30 provided by provider 28 to LIHEAP qualified clients 65 (FIG. 1) identified in database 62 (FIG. 1). Assistance program enrollment process 36 includes program code executed on managing computing system 32 in conjunction with payment guarantee process 34 that makes assistance program 86 offered by provider 28 available to LIHEAP qualified clients 65 and facilitates enrollment of LIHEAP qualified clients 65 into assistance program 86.

Payment guarantee process 34 begins with a task 88. At task 88, managing computing system 32 receives an access request for initiation of payment guarantee process 34 from one of organizations 24 (FIG. 1) authorized to utilize payment guarantee process 34. An access request may be, for example, log-in identification and a password and a request to guarantee payment of some or all of a bill owed by one of clients 65 (FIG. 1) for electricity 30 (FIG. 1).

In response to task 88, processor 38 (FIG. 1) initiates execution of assistance program enrollment process 36. More specifically, process control continues with a task 90. At task 90, processor 38 accesses one of customer records 77 from, for example, database 76 (FIG. 1) related to one of customers 78 and 84 (FIG. 1) who is also one of clients 65. Some information available in the accessed one of customer records 77 can include whether that one of customers 78 and 84 is currently qualified for LIHEAP assistance and currently owes a payment to provider 28 for the cost of electricity 30.

Following task 90, process control continues with a query task 92. At query task 92, assistance program enrollment process 36 executed by processor 38 (FIG. 1) determines whether the one of customers 78 and 84 is already enrolled in assistance program 86 (FIG. 1). When the one of customers 78 and 84 is already enrolled, i.e., is one of customers 84, assistance program enrollment process 36 exits and payment guarantee process 34 continues with a task 94 (discussed below). Referring briefly to FIG. 1 by way of illustration, one of clients 65 in database 62 having client identifier 68 of “CLIENT C” is also represented in database 76 as one of customers 84.

However, when query task 92 determines that the one of customers 78 and 84 is not currently enrolled in assistance program 86 (FIG. 1), i.e., the one of customers is one of customers 78, assistance program enrollment process 36 continues with a query task 96. Again referring briefly to FIG. 1 by way of illustration, one of clients 65 in database 62 having client identifier 68 of “CLIENT A” is also represented in database 76 as one of customers 78. At query task 96, a determination is made as to whether the customer 78 is eligible for enrollment into assistance program 86.

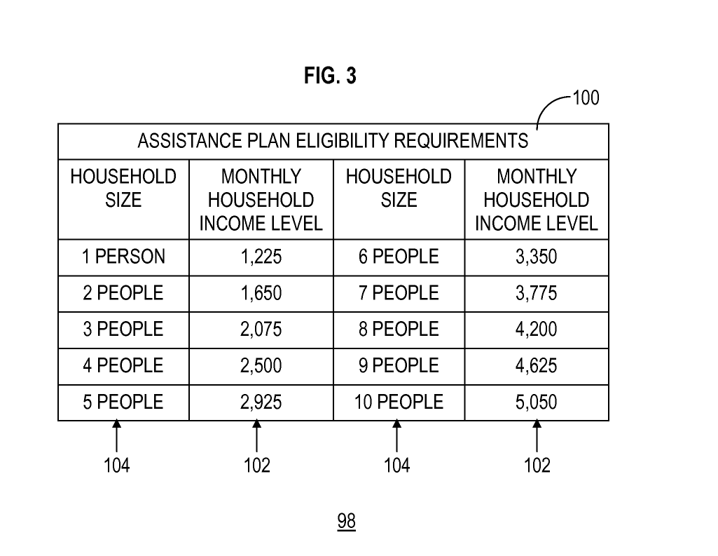

Referring to FIG. 3 in connection with query task 96, FIG. 3 shows a table 98 of eligibility requirements 100 for assistance program 86 offered by provider 28 (FIG. 10). Eligibility requirements 100 for assistance program 86 may be a monthly household income threshold 102 relative to a household size 104. In one embodiment, eligibility requirements 100 for assistance program 86 may coincide with the HHS poverty income guidelines for determining the qualification of clients 65 for LIHEAP assistance. Accordingly, household income value 70 (FIG. 1) and household size value 72 (FIG. 1) for that one of LIHEAP clients 65 who is one of customers 78 of provider 28 (FIG. 1) can be readily compared against income threshold 102 established relative to a household size 104 to determine eligibility of the one of LIHEAP clients 65 to enroll in assistance program 86. Client information 66 (FIG. 1) from LIHEAP application 64 (FIG. 1) is advantageously utilized because the information provided therein is commonly required for qualification for LIHEAP assistance and to determine eligibility for enrollment in provider 28 offered assistance program. Moreover, that client information 66 has already been verified by an independent authorizing agency.

In other embodiments, different eligibility requirements 100 then those specified above may be utilized by provider 28 to determine eligibility for enrollment in assistance program 86. However, the previously acquired and verified client information 66 (FIG. 1) regarding at least household income value 70 and household size value 72 can still be compared against these different eligibility requirements to determine eligibility for enrollment in assistance program 86.

With reference back to assistance program enrollment process 36 of FIG. 2, when a determination is made at query task 96 that client 65 who is also customer 78 of provider 28 is not eligible for enrollment in assistance program 86 (FIG. 1), assistance program enrollment process 36 exits, and payment guarantee process 34 continues with task 94, discussed below. However, when the client 65 is eligible for enrollment in assistance program 86, assistance program enrollment process 36 continues with a task 106.

At task 106, managing computing system 32 (FIG. 1) notifies organization 24 (FIG. 1) of client eligibility for assistance program 86.

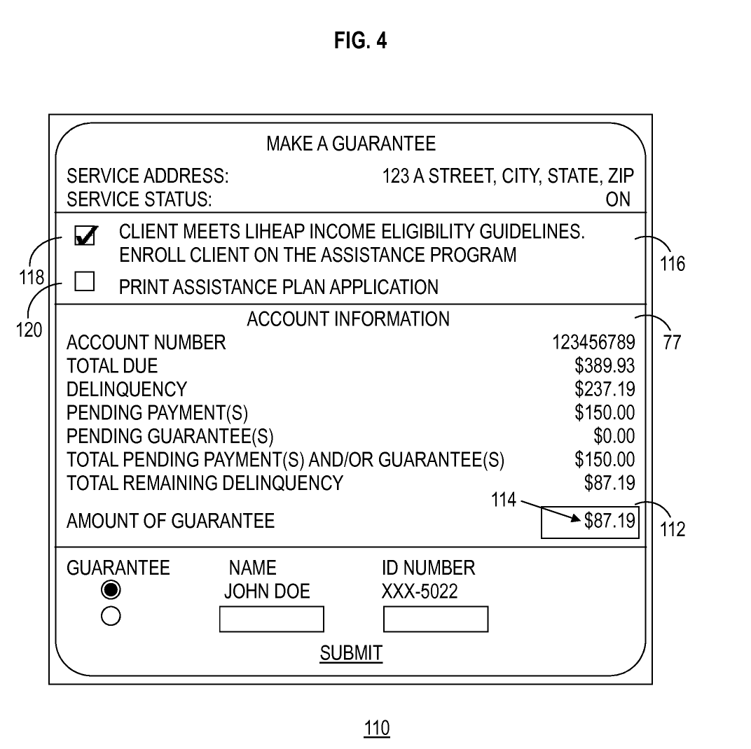

Referring to FIG. 4 in connection with task 106, FIG. 4 shows a view of a screen shot 110 in which enrollment for an eligible one of client 65 to assistance program 86 is made available to organization 24 in accordance with an embodiment of the present invention. Screen shot 110 may be provided on display 56 (FIG. 1) at organization computing system 24 (FIG. 1) and shows customer record 77 for one of clients 65. Customer record 77 can include a total due, a delinquency amount, pending payment from client 65, pending guarantee from organization 24, a delinquent amount still owed, and a data entry box 112 for enabling organization to specify a guarantee amount 114.

In accordance with the present invention, when client 65 is eligible for assistance program 86, an assistance program prompt box 116 will be provided in screen shot 110. In this example, assistance program prompt box 116 allows organization 24 to make a number of choices. For example, organization 24 can select an enroll prompt 118, represented herein by a check box preceding “CLIENT MEETS LIHEAP INCOME ELIGIBILITY GUIDELINES. ENROLL CLIENT ON ASSISTANCE PROGRAM.” Enroll prompt 118 will cause the automatic application of client 65 into assistance program 86. Thus, organization 24 can apply for assistance program 86 on behalf of client 65. Alternatively, organization 24 can select a print prompt 120, represented herein by a check box preceding “PRINT ASSISTANCE PROGRAM APPLICATION.” Print prompt 120 will result in the generation of an application for assistance program 86. Thus, organization 24 is prompted about assistance program 86, can print an application on behalf of client 65, and can subsequently share that application to client 65 so that client 65 can decide whether he/she wishes to enroll in assistance program 86.

With reference back to assistance program enrollment process 36 (FIG. 2), following task 106, process control continues with a query task 120. At query task 120, a determination is made as to whether authorization is received at managing computing system 32 (FIG. 1) from organization 24 to enroll client 65 into assistance program 86. When authorization is not received, assistance program enrollment process 36 exits, and payment guarantee process 34 continues with task 94, discussed below. When authorization is received from organization 24 at query task 120, assistance program enrollment process 36 continues with a task 122.

At task 122, utility manager 22, via managing computing system 32, or alternatively provider 28 enrolls client 65 into assistance program 86 (FIG. 1). Additional text may be provided on display 56 (FIG. 1) in response to enrollment instructing organization 24 to inform client 65 that assistance program 86 expires after a year, and that notification will be sent to them to re-enroll to stay in assistance program 86.

Following task 122, and as mentioned above, when client 65 is already enrolled in assistance program 86 at query task 92, when client 65 is ineligible for enrollment in assistance program 86 at query task 96, or when authorization to enroll client 65 is not received at query task 120, payment guarantee process 34 continues with task 94.

At task 94, payment guarantee process 34 activities are continued. Such activities can include the commitment or guarantee of payment of at least a portion of the cost specified in record 77 (FIG. 4) for electricity 30 provided by provider 28. Following task 94, payment guarantee process 34 exits. Of course, it should be understood that the above described payment guarantee process 34 with embedded assistance program enrollment process 36 can be repeated any number of times for any number of clients 65.

In summary, the present invention teaches of a method and computer readable code for making an assistance program offered by a provider available to individuals. Enrollment information is effectively disseminated to those who are most in need by coupling notification of eligibility for enrollment in a provider offered assistance program with a payment guarantee process for a social benefit program administered by agencies or organizations. Thus, the agencies or organizations are cognizant of the provider offered assistance program, disseminate that information to their clients, and readily enroll them in the assistance program. Since the clients have previously qualified for a social benefit program, verified income and household size data exists for that client. This verified income and household size data can be used to determine eligibility in the assistance program, thus greatly reducing the potential for fraudulent users of such an assistance program.

Although the preferred embodiments of the invention have been illustrated and described in detail, it will be readily apparent to those skilled in the art that various modifications may be made therein without departing from the spirit of the invention or from the scope of the appended claims. For example, as mentioned above the assistance program enrollment process need not be coupled with a payment guarantee process. In addition, eligibility requirements need not be determined through LIHEAP qualification but can instead be determined from another verifiable data source, such as applications for Earned Income Tax Credit, U.S. Department of Agriculture's Food Stamp Program, Children's Health Insurance Program, and other publicly or privately funded and administered programs.

What is claimed is:

1. In a computing environment, a method of making an assistance program offered by a provider available to a client comprising:
receiving, at said computing environment, client information pertaining to a social benefit program for which said client qualifies from an organization that administers said social benefit program;
comparing said client information with eligibility requirements for said assistance program;
when said client information meets said eligibility requirements, notifying said organization of an eligibility of said client to enroll in said assistance program; and
facilitating enrollment of said client in said assistance program in response to said notifying operation.

2. A method as claimed in claim 1 wherein when said client information meets said eligibility requirements, said method further comprises:
determining whether said client is currently enrolled in said assistance program; and
when said client is currently enrolled in said assistance program abstaining from performing said notifying and facilitating operations.

3. A method as claimed in claim 1 further comprising:
determining that said client information fails to meet said eligibility requirements for said assistance program; and
abstaining from performing said notifying and facilitating operations in response to said determining operation.

4. A method as claimed in claim 1 wherein said facilitating operation comprises generating an application for said assistance program on behalf of said client.

5. A method as claimed in claim 1 wherein said facilitating operation comprises applying for said assistance program on behalf of said client.

6. A method as claimed in claim 5 wherein said applying operation is performed by said organization.

7. A method as claimed in claim 1 wherein said provider provides a product that has an associated cost, said cost is specified in a record, and said method further comprises:
providing said record to said organization via said computing environment; and
allowing said organization to guarantee payment of at least a portion of said cost presented in record.

8. A method as claimed in claim 7 wherein said facilitating operation comprises concurrently enrolling said client in said assistance program when said portion of said cost is guaranteed by said organization.

9. A method as claimed in claim 1 wherein said assistance program is a low-income discount program for a product provided by said provider, and said client information received at said computing environment includes verified income information for said client.

10. A method as claimed in claim 9 wherein said eligibility requirements includes an income threshold and said comparing operation compares said verified income information for said client to said income threshold to determine said eligibility of said client to enroll in said assistance program.

11. A method as claimed in claim 1 wherein said client information includes information commonly required by both said social benefit program and said assistance program.

12. A method as claimed in claim 1 wherein said facilitating operation comprises providing an eligibility statement via a display within said computing environment, said eligibility statement indicating said eligibility of said client to enroll in said assistance program.

13. A computer-readable storage medium containing executable code for instructing a processor to make a low-income discount program offered by a provider available to a client, said executable code instructing said processor to perform operations comprising:
receiving client information pertaining to a social benefit program for which said client qualifies from an organization that administers said social benefit program, said client information including verified income information for said client that is commonly required by both said social benefit program and said low-income discount program;
comparing said client information with eligibility requirements for said low-income discount program;
when said client information meets said eligibility requirements, notifying said organization of an eligibility of said client to enroll in said low-income discount program; and
facilitating enrollment of said client in said low-income discount program in response to said notifying operation.

14. A computer-readable storage medium as claimed in claim 13 wherein said executable code further instructs said processor to perform operations comprising:
determining whether said client is currently enrolled in said low-income discount program; and
when said client is currently enrolled in said assistance program abstaining from performing said notifying and facilitating operations.

15. A computer-readable storage medium as claimed in claim 13 wherein said executable code further instructs said processor to perform operations comprising:
determining that said client information fails to meet said eligibility requirements for said low-income discount program; and
abstaining from performing said notifying and facilitating operations in response to said determining operation.

16. A computer-readable storage medium as claimed in claim 13 wherein said eligibility requirements includes an income threshold, and said executable code further instructs said processor to compare said verified income information for said client to said income threshold to determine said eligibility of said client to enroll in said assistance program.

17. A computing environment comprising:
a first computing system including a processor;
a second computing system operable by an organization that administers a social benefit program, said second computing system being in selective communication with said first computing system for communicating client information pertaining to said social benefit program for which said client qualifies, said client information including verified income information; and
a computer-readable storage medium containing executable code for instructing said processor at said first computing system to make a low-income discount program for a product offered by a provider available to said client, said executable code instructing said processor to perform operations comprising:
receiving said client information from said second computing system;
comparing said verified income information for said client with eligibility requirements for said low-income discount program;
when said verified income information meets said eligibility requirements, notifying said organization of an eligibility of said client to enroll in said low-income discount program; and
facilitating enrollment of said client in said low-income discount program in response to said notifying operation by providing to said organization an eligibility statement via a display of said second computing system, said eligibility statement indicating said eligibility of said client to enroll in said low-income discount program.

18. A computing environment as claimed in claim 17 wherein said executable code instructs said processor to perform further operations comprising:
receiving application information for said low-income discount program on behalf of said client from said organization via said second computing system; and
enrolling said client in said low-income discount program.

19. A computing environment as claimed in claim 17
wherein said provider provides a product that has an associated cost, said executable code instructs said processor to perform further operations comprising:
providing a record specifying said cost to said organization via said computing environment;
allowing said organization to guarantee payment of at least a portion of said cost presented in record; and
concurrently enrolling said client in said low-income discount program when said portion of said cost is guaranteed by said organization.

20. A computing environment as claimed in claim 17 wherein said second computing system provides to said first computing system said client information that includes information commonly required by both said social benefit program and said low-income discount program.
